(19) United States
(12) Patent Application Publication
(10) Pub. No.: US 2010/0217941 A1
(43) Pub. Date: Aug. 26, 2010

(54) IMPROVING THE EFFICIENCY OF FILES SEVER REQUESTS IN A COMPUTING DEVICE

(75) Inventor: Peter Scobie, Northants (GB)

Correspondence Address: FOX ROTHSCHILD LLP, 997 Lenox Drive, Building 3, Lawrenceville, NJ, 08648, US

(73) Assignee: SYMBIAN SOFTWARE LTD., London (GB)

(21) Appl. No.: 12/063,249

(22) PCT Filed: Aug. 8, 2006
(86) PCT No.: PCT/GB2006/002963

§ 371 Date: Mar. 15, 2010

(30) Foreign Application Priority Data
Aug. 10, 2005 (GB) 0516444

(51) Int. Cl. G06F 12/00

(52) U.S. Cl. 711/154; 711/E12.001

(57) ABSTRACT

A computing system is operated such that its file server is arranged not to block a client application and distinguishes between synchronous devices, which respond to requests immediately, and asynchronous devices, which do not. For asynchronous devices, it also distinguishes between synchronous operations, which complete immediately, and asynchronous operations, which take time to complete. The device drivers for the computing system only pass file server requests to separate drive threads when they involve asynchronous operations made on asynchronous devices.

This invention discloses a method of operating a computing device, and in particular to a method for improving efficiency in the operation of a computing device by minimising the time needed for performing file server requests within the device.

The term ‘computing device’ includes, without limitation, desktop computers, laptop computers, PDAs, Mobile Telephones, Smartphones, Digital Cameras and Digital Music Players. It also includes converged devices incorporating the functionality of one or more of the classes of device already mentioned, together with many other industrial and domestic electronic appliances.

All these computing devices need some type of permanent data storage facility. The standard method of storing data in modern computer systems is via a file system which transfers data to the physical storage medium, which is generically known as a disk irrespective of what hardware actually happens to be used. Data on disk is usually kept in a series of files; a file may be defined as a stream or sequence of bits stored as a single unit (see http://en.wikipedia.org/wiki/Computer_file). So important is this aspect of the overall functionality of the operating system of a computing device that Microsoft referred to its first microcomputer operating system as DOS, which stands for Disk Operating System.

Access to the data held in the file system is the responsibility of that portion of the operating system known variously as the file manager or the file server, which traditionally provides directory service for locating named files on disk, and allows common operations to be performed on them such as being opened, closed, written to, read from, renamed and deleted.

The file server on a computing device can be looked on as an insulation layer between a software application and the hardware component on which the data is actually stored. Application software does not need to know anything at all about the type of hardware being used for storage; all storage media types are accessed via the same Application Program Interface (API). Access to the storage hardware itself is typically handled via some type of device driver. Device drivers are typically components that plug into the file server and this enables different types of physical storage media to be used in a manner which is transparent to a user of the device.

The current practice in modern operating systems is for the file server to pass file system calls received from its client applications to the physical storage device via the device driver, and to pass any returned values or data received back from the file server to the client application making the original call. The interface between the file server and its clients is always consistent irrespective of the device driver or the hardware in use.

On multitasking computer systems, it is usual for calls made to and from the file server and its device driver to the appropriate drive hardware to be asynchronous; they return immediately without waiting for the requested operation to be completed, with the file server being notified of the result of the operation at some later point in time, via a callback or a some other type of notification mechanism. Were the calls to be synchronous, and block until the requested operation has been completed, the entire file server would be prevented from servicing other requests, possibly involving other media types and other device drivers, while waiting for each operation to complete. Where asynchronous calls are made, it is usual for file server operations requiring hardware accesses to be passed by the device driver to a different thread of execution it has set up specifically for this purpose, known here as the drive thread.

Because of the centrality of the storage and retrieval of data to the functioning of most computing devices, one of the key determinants of the performance of a device has always been the efficiency of its file system.

Current file server designs are relatively inefficient because, as described above, the file server normally passes calls asynchronously from its clients on to the physical device via the device driver. However, asynchronous calls are significantly more complex to manage than synchronous calls. As well as managing notifications and callbacks, transferring control of an operation to a different thread is computationally expensive. Synchronous versions of these operations are much simpler to manage and have a much smaller computing overhead.

The penalty of making an asynchronous call is of course worth incurring for lengthy file system calls, as it is very inefficient for the file server to be blocked. However, it is not always the case that every call made to and by the file server takes a long time to complete; where an operation completes extremely quickly, it is far more efficient to use a synchronous method rather than incurring the unnecessary overhead of making an asynchronous call.

In many cases, the overhead of making an asynchronous call involving a separate drive thread requires more computing resources than would be required to perform the operation directly. This is inefficient, slows down the computing device, and wastes power; this last drawback is a particularly serious issue for mobile battery operated computing devices such as mobile phones, which have limited computing power and are typically battery-operated.

This invention, therefore, seeks to provide a method of minimising the time needed for performing file server requests by distinguishing between those file server operations that take a relatively long time to complete and require hardware access, and those that complete very quickly, in relative terms, and require no hardware access.

According to a first aspect of the present invention there is provided

According to a second aspect of the present invention there is provided

According to a third aspect of the present invention there is provided

Embodiments of the present invention will now be described, by way of further example only, with reference to the accompanying drawings, in which:—

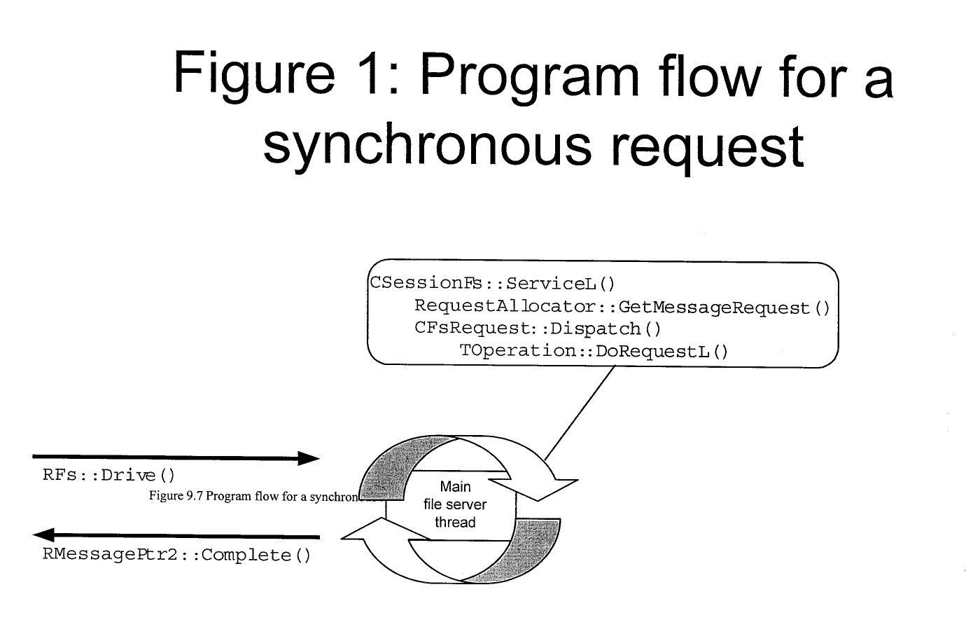

FIG. 1 shows an example of a synchronous file server operation;

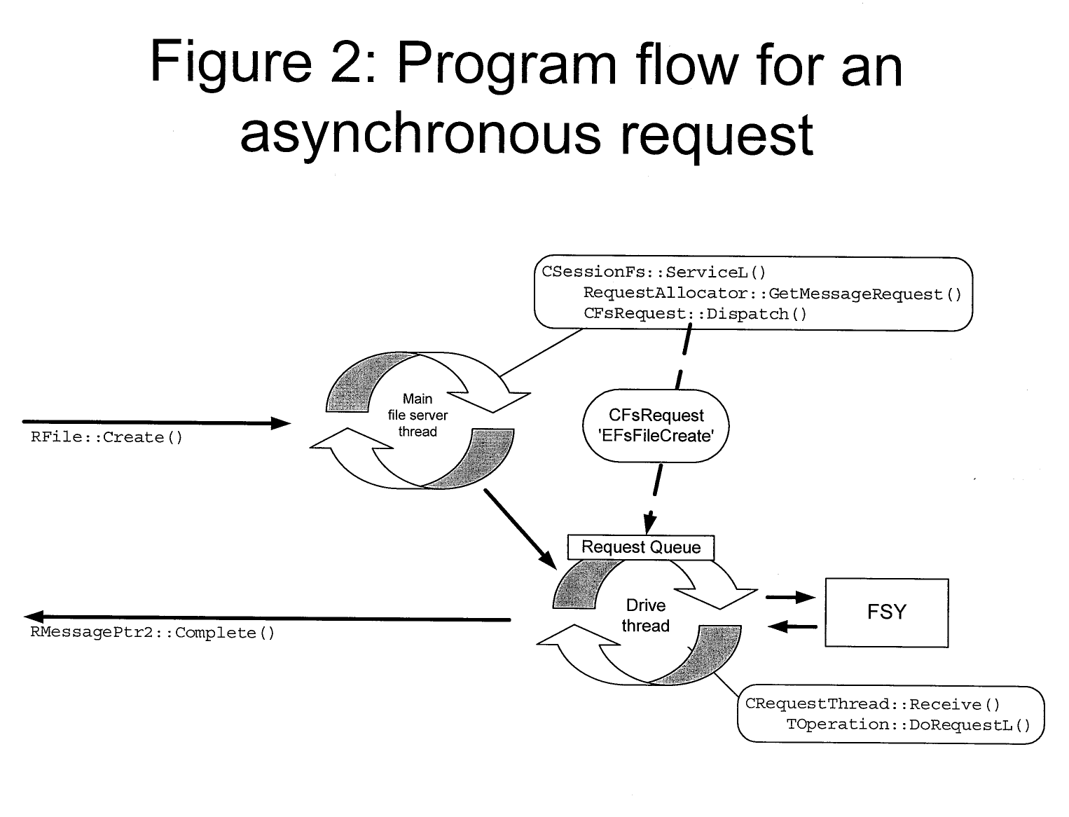

FIG. 2 shows an example of an asynchronous file server operation; and

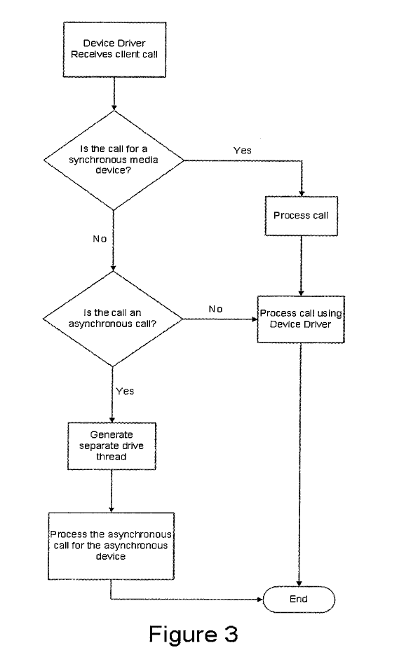

FIG. 3 shows a procedure for accessing a media storage system in accordance with the present invention.

With the present invention as many file server requests as possible are arranged to be handled in the main file server thread without accessing the media data storage of the computing device; these include all synchronous operations and all operations performed on synchronous drives. The term synchronous here means almost real-time. As an example, any operation that would take longer to transfer to the drive thread than to execute in the main file server thread should, in the context of this invention, be regarded as synchronous.

FIGS. 1 and 2 show the operation of synchronous and asynchronous operations respectively, using objects and classes taken from the file server used by Symbian OS, the operating system for mobile telephones developed by Symbian Software Ltd of London, UK. It can be seen from the synchronous operation shown in FIG. 1 that the main file server thread completes before the requesting client is notified that the requested call has been completed. The file server is therefore blocked from servicing requests from other clients until the notification of request completion has been made. In contrast, with the asynchronous operation shown in FIG. 2, the main file server thread gives rise to a separate independent drive thread which carries out the requested operation and advises the requesting client when the requested operation has been completed. The file server is therefore free to service requests from other clients before the request from the current client has been completed, but at the expense of having to create the separate thread, and the resource implications of this.

FIG. 3 shows the operation of the present invention. With the present invention, the main file server thread initially handles all client requests as in the conventional model described above. However, the device driver of the file server is arranged to service synchronous requests itself; these include all those requests that do not require any access to the media device itself as well as those that will not block a thread before completing and returning the result to the client.

The file server is arranged so that it only passes to the drive thread those requests that involve a call down to the hardware file system or calls that may block the file server. In this way, incurring the fixed overhead in transferring requests to a separate drive thread is avoided, wherever possible.

Some types of drive, such as those implemented in Read Only Memory (ROM) hardware, and internal drives using Random Access Memory (RAM), never perform long-running operations; they are very fast and never block the drive thread. These drives are therefore designated as synchronous drives, and all requests for them from a client application are processed in the main file server thread. Thus, with the present invention, synchronous drives are not serviced through the use of a separate drive thread.

Even with slower (asynchronous) drives, certain requests can be handled without access to the storage media device itself—for example, requests to set or retrieve information held by the file server. In this invention, these types of operation are classified as “synchronous operations” and the main file server thread also always processes these.

The preferred implementation of this invention is for the device driver for any particular hardware device to decide whether that device is a synchronous device or not; and for device drivers for asynchronous drives to distinguish between those calls that are synchronous and those that are not. By doing so, the device drivers for such a computing system can be operated such that they only pass file server requests to separate drive threads when they involve asynchronous operations made on asynchronous media devices.

It can be realised, therefore, that the present invention makes computing devices quicker and more responsive. It also makes the devices more efficient, since fewer computational resources are used and fewer hardware accesses are made. Thus, there is a saving in power consumption for common file operations.

Accordingly, the present invention provides a computing device implementing a filing system that does not block its client and distinguishes between synchronous devices, which respond to requests immediately, and asynchronous devices, which do not. For asynchronous devices, it also distinguishes between synchronous operations, which complete immediately, and asynchronous operations, which take time to complete. The device drivers for such a computing system only pass file server requests to separate drive threads when they involve asynchronous operations made on asynchronous devices.

Although the present invention has been described with reference to particular embodiments, it will be appreciated that modifications may be effected whilst remaining within the scope of the present invention as defined by the appended claims.

1. A method of accessing storage systems of a computing device having a file server arranged to use a thread of execution for handling access to storage systems on behalf of an application running on the device; the method comprising
a. distinguishing between those storage systems which respond to access requests from the application in a synchronous manner (synchronous systems) and those storage systems which respond to access requests from the application in an asynchronous manner (asynchronous systems); and
b. arranging that the file server device does not pass an access request for an asynchronous system to any thread of execution other than the said thread of execution.

2. A method according to claim 1 wherein the time taken for inter-thread communications on the computing device is used to distinguish between the synchronous and asynchronous systems.

3. A method according to claim 1 further comprising, for asynchronous systems, distinguishing between synchronous operations and asynchronous operations, and arranging not to pass access requests for synchronous operations on asynchronous systems to any thread of execution other than the said thread of execution.

4. A method according to claim 3 wherein the time taken for inter-thread communications on the computing device is used to distinguish between the synchronous and asynchronous operations.

5. A method according to claim 1 wherein the file server is arranged to load one or more device drivers which are responsible for classifying which systems and which operations on systems are synchronous and which are asynchronous.

6. A method according to claim 5 wherein the device drivers are arranged to pass calls for asynchronous operations on asynchronous systems to separate threads of execution.

7. A computing device arranged to operate in accordance with a method as claimed in claim 1.

8. An operating system for causing a computing device to operate in accordance with a method as claimed in claim 1.
